(19) United States
(12) Patent Application Publication
(10) Pub. No.: US 2025/0373644 A1
(43) Pub. Date: Dec. 4, 2025

(54) AI-ENABLED DEVICE OWNERSHIP IDENTIFICATION FOR SECURING NATIONWIDE CRITICAL INFRASTRUCTURE SYSTEMS

(71) Applicant: Palo Alto Networks, Inc., Santa Clara, CA (US)

(72) Inventors: Sydney Marie Wong, Berkeley, CA (US); Christina Papadimitriou, Brooklyn, NY (US); Abigail Marie Smigelski, Alexandria, VA (US); Kelsey Taylor Ball, Austin, TX (US); Phillip Dietz Galonsky, Portland, ME (US); Aaron Isaksen, Brooklyn, NY (US); Timothy James Hofmockel, Washington, DC (US); Evan Millspaugh Pikulski, Arlington, VA (US); James Thomas O'Donnell, Denver, CO (US); Aaron Tianqin Cao, Atlanta, GA (US)

(21) Appl. No.: 18/680,921

(22) Filed: May 31, 2024

(51) Int. Cl. H04L 9/40

(52) U.S. Cl. CPC H04L 63/1433

(57) ABSTRACT

Various techniques for providing artificial intelligence-enabled (AI-enabled) device ownership identification for securing nationwide critical infrastructure systems are disclosed. In some embodiments, a system/process/computer program product for providing artificial intelligence-enabled (AI-enabled) device ownership identification for securing nationwide critical infrastructure systems includes discovering vulnerable devices across a plurality of networks; automatically identifying device owners using a large-language model (LLM); and automatically enriching the discovered vulnerable devices with sector, location, and point of contact (POC) information.

### BACKGROUND OF THE INVENTION

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

### BRIEF DESCRIPTION OF THE DRAWINGS

Various embodiments of the invention are disclosed in the following detailed description and the accompanying drawings.

FIG. 1 illustrates an overview of a system for AI-enabled device ownership identification for securing nationwide critical infrastructure systems in accordance with some embodiments.

FIG. 2 illustrates an example of a sector-based impact analysis of a known exploited vulnerability in accordance with some embodiments.

FIG. 3 illustrates an example of a region-based impact analysis of a known exploited vulnerability in accordance with some embodiments.

FIG. 4 illustrates an example system architecture for an AI-enabled device ownership identification system for securing nationwide critical infrastructure systems in accordance with some embodiments.

FIG. 5 illustrates an example for prompting an LLM for asset owners of vulnerable devices in accordance with some embodiments.

FIG. 6 illustrates an example full prompt of an LLM for asset owners of vulnerable devices in accordance with some embodiments.

FIG. 7 illustrates an asset owner example input in accordance with some embodiments.

FIG. 8 illustrates an example output generated using the AI-enabled device ownership identification system for securing nationwide critical infrastructure systems in accordance with some embodiments.

FIG. 9 illustrates an asset remediation solution using the AI-enabled device ownership identification system for securing nationwide critical infrastructure systems in accordance with some embodiments.

FIG. 10 illustrates a workflow example using the AI-enabled device ownership identification system for securing nationwide critical infrastructure in accordance with some embodiments.

FIG. 11 is a flow diagram for providing artificial intelligence-enabled (AI-enabled) device ownership identification for securing nationwide critical infrastructure systems in accordance with some embodiments.

FIG. 12 is another flow diagram for providing artificial intelligence-enabled (AI-enabled) device ownership identification for securing nationwide critical infrastructure systems in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Overview of Technical Challenges for Securing Nationwide Critical Infrastructure Systems

There exists a need for rapidly identifying vulnerable devices for incident response at a large scale (e.g., nationwide scale).

For example, various national cybersecurity entities generally need to rapidly identify vulnerable devices for incident response at a national scale.

However, there currently is insufficient real-time visibility of a nationwide attack surface, which includes Internet-accessible devices and networks associated with various systems, such as hospitals, schools, and critical infrastructure systems. This lack of visibility hinders the ability to identify and mitigate potential vulnerabilities effectively.

Also, there exists significant difficulty in accurately attributing devices to their respective owners, particularly in large-scale, complex systems. This presents challenges in determining which entities are responsible for addressing specific vulnerabilities and coordinating remediation efforts.

Further, there presently is limited scalability in existing solutions, making it difficult to provide effective nationwide incident responses for entities that fall outside the scope of existing coverage and to provide real-time, comprehensive information for millions of distinct IP addresses and network-connected devices.

### Overview of Techniques for AI-Enabled Device Ownership Identification for Securing Nationwide Critical Infrastructure Systems

As such, new and improved techniques for securing nationwide critical infrastructure systems is needed.

Accordingly, various techniques for providing artificial intelligence-enabled (AI-enabled) device ownership identification for securing nationwide critical infrastructure systems are disclosed.

In some embodiments, a system/process/computer program product for providing artificial intelligence-enabled (AI-enabled) device ownership identification for securing nationwide critical infrastructure systems includes discovering vulnerable devices across a plurality of networks; automatically identifying device owners using a large-language model (LLM) (e.g., the LLM can be prompted to facilitate identifying device owners including instructions to prioritize predetermined information for identifying device owners); and automatically enriching the discovered vulnerable devices with sector, location, and point of contact (POC) information.

For example, nationwide incident response to known exploited vulnerabilities can be performed using the discovered vulnerable devices, identified device owners, and enriched information associated with the discovered vulnerable devices.

In some embodiments, a system/process/computer program product for providing AI-enabled device ownership identification for securing nationwide critical infrastructure systems further includes generating an output that includes a plurality of fields including device information, IP address, location information, device owner information, and POC information.

In some embodiments, a system/process/computer program product for providing AI-enabled device ownership identification for securing nationwide critical infrastructure systems further includes executing an asset owner model to facilitate identifying device owners.

In some embodiments, a system/process/computer program product for providing AI-enabled device ownership identification for securing nationwide critical infrastructure systems further includes executing a point of contact model, a headquarters location model, and a sector model to facilitate automatically enriching the discovered vulnerable devices with sector, location, and POC information.

For example, the disclosed techniques for AI-enabled device ownership identification for securing nationwide critical infrastructure systems address an increasing need for rapidly identifying vulnerable devices for incident response at a national scale similarly discussed above.

In an example implementation, the disclosed techniques for AI-enabled device ownership identification for securing nationwide critical infrastructure systems includes the following: (1) AI-enabled device ownership identification; (2) actionable business intelligence (BI); (3) sector-based vulnerability analysis (e.g., based on, for example, predetermined critical infrastructure sectors, such as specified by a national cybersecurity entity, or other sector definitions can similarly be applied); (4) scalability and performance (e.g., scaling to support identification for 50 million or more devices per week); and (5) explainability (e.g., providing ML model explanations on attribution decisions). Each of these aspects is further described below.

First, AI-enabled device owner identification can be effectively and efficiently performed by incorporating ML/LLM models that accurately attribute devices to their respective owners nationwide (e.g., can scale to support identification for 50,000,000 devices per week), such as further described below. For example, this facilitates the identification of responsible entities for addressing specific vulnerabilities and streamlines the coordination of remediation efforts among stakeholders.

Second, actionable Business Intelligence (BI) can be effectively and efficiently performed by incorporating an ML/LLM mechanism combined with business intelligence data sources that accurately identify sector, location, and contact information for each device owner nation-wide, such as further described below. For example, by answering important questions related to affected systems, asset ownership, notification methods, and follow-on support, this BI capability enables rapid and efficient response to emerging threats.

Third, sector-based vulnerability analysis can provide the ability to analyze and understand the sectors impacted the most by a specific Common Vulnerability and Exposure (CVE) or vulnerability, such as further described below. For example, this enables stakeholders to prioritize their response and remediation efforts, focusing on the sectors that face the highest risk and potential consequences.

Fourth, scalability and performance are provided using the disclosed techniques for AI-enabled device ownership identification for securing nationwide critical infrastructure systems that are designed to be highly scalable, capable of providing real-time, comprehensive information for millions of distinct IP addresses and devices belonging to numerous registrants, such as further described below. For example, the disclosed techniques for AI-enabled device ownership identification for securing nationwide critical infrastructure systems can also accurately identify asset owners of devices hosted in the cloud, ensuring effective coverage of critical infrastructure entities beyond the scope of existing systems while delivering timely and accurate insights.

As such, by integrating these components and functionalities, the disclosed techniques for AI-enabled device ownership identification for securing nationwide critical infrastructure systems offer a transformative approach to securing vulnerable devices at scale. Specifically, through AI-driven continuous monitoring, accurate device attribution, and actionable business intelligence (BI), the solution empowers stakeholders to identify and mitigate threats, enhance incident response capabilities, and ultimately safeguard the essential systems nation-wide, such as will be further described below.

Further, the disclosed techniques for AI-enabled device ownership identification for securing nationwide critical infrastructure systems provide significant advances over existing solutions for asset identification and attack surface management at scale.

For example, the disclosed techniques for AI-enabled device ownership identification for securing nationwide critical infrastructure systems facilitate precise device identification. Specifically, the solution includes a system for inferring and extracting attributes for Internet-connected devices continuously across the entire Internet, including by manufacturer, product, model, and version.

As another example, the disclosed techniques for AI-enabled device ownership identification for securing nationwide critical infrastructure systems provide for precise device attribution. Specifically, the solution includes an intelligent mechanism for attributing devices to their respective owners at scale and provides a more accurate and streamlined approach to coordinating remediation efforts among stakeholders. This provides more accurate owner identification than other solutions that assign device owners based on IP registrant only, which is often not the device owner.

As yet another example, the disclosed techniques for AI-enabled device ownership identification for securing nationwide critical infrastructure systems provide actionable business intelligence. Specifically, the machine learning-powered Business Intelligence (BI) tool delivers actionable information, such as headquarters location and point of contact, during exploit campaigns and zero-day incidents, allowing entities to rapidly and efficiently respond to emerging threats. This real-time, data-driven approach significantly improves the effectiveness of incident response compared to traditional methods that rely less on AI and automation.

These and other aspects for AI-enabled device ownership identification for securing nationwide critical infrastructure systems will be further described below with respect to various embodiments.

### Example System Embodiments for AI-Enabled Device Ownership Identification for Securing Nationwide Critical Infrastructure Systems

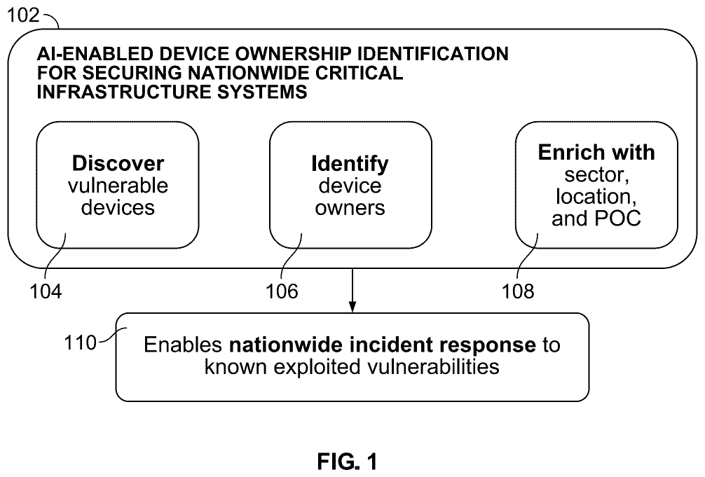

FIG. 1 illustrates an overview of a system for AI-enabled device ownership identification for securing nationwide critical infrastructure systems in accordance with some embodiments. Specifically, FIG. 1 illustrates an AI-powered tool 102 that provides AI-enabled device ownership identification for securing nationwide critical infrastructure systems.

As shown in FIG. 1, AI-powered tool 102 is provided that performs the following: (1) discovers vulnerable devices 104 (e.g., vulnerable devices can be identified by IP address, port, etc.); (2) identifies the owner of that device 106 (e.g., a company or organization that is the asset owner of the device); and (3) enriches that information with additional information about the company 108 (e.g., what sector it belongs to, such as communications sector, electrical/power sector, transportation sector, government facilities sector, etc.; where is it located, such as City, County, State, Country, etc.; and a point-of-contact within the organization to contact for remediation, such as an entity/company web site and an email address, etc.).

As shown at 110, the AI-powered tool facilitates nationwide incident response to known exploited vulnerabilities. Each of these components of the AI-powered tool shown in FIG. 1 will be further described below with respect to various embodiments.

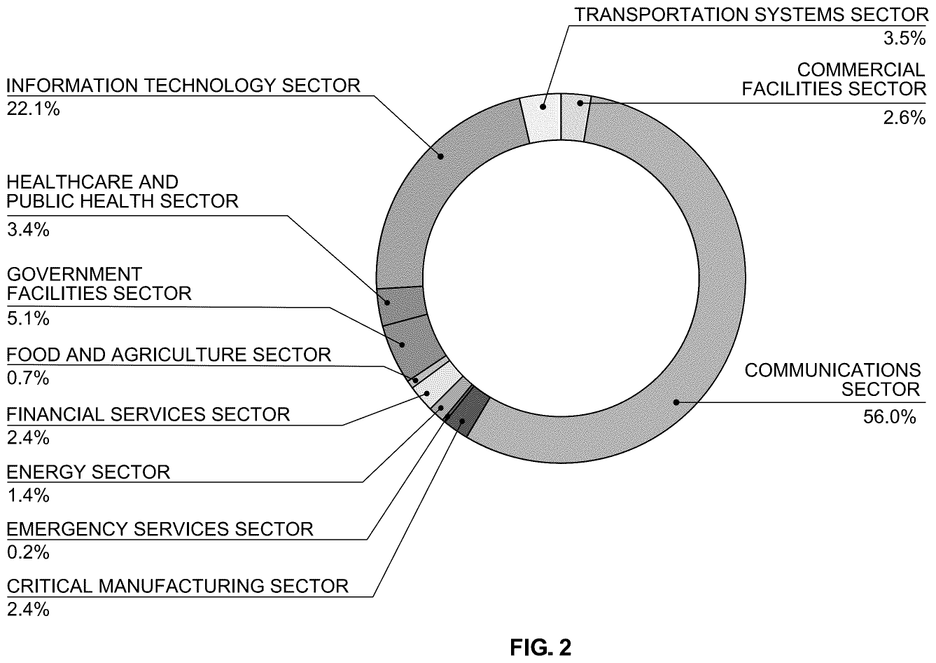

FIG. 2 illustrates an example of a sector-based impact analysis of a known exploited vulnerability in accordance with some embodiments.

For example, Cisco devices were recently hacked via an IOS XE zero-day vulnerability tracked as CVE-2023-20198 that was being exploited to hack the Cisco devices. The disclosed AI-powered tool could be used by a national cybersecurity entity (e.g., or another entity, in which, for example, the disclosed AI-powered tool can be used by a government entity to understand the impact of CVEs across critical infrastructure of a state, nation, and/or other geographical region, sector, etc.) to better understand the impact of CVE-2023-20198 across the national critical infrastructure of the United States. In this example use case, the AI-powered tool effectively and efficiently identified approximately 10,000 devices across approximately 1,000 device owners.

Specifically, FIG. 2 illustrates an example of a sector-based impact analysis of the IOS XE zero-day vulnerability tracked as CVE-2023-20198 that was being exploited to hack the Cisco devices. As shown, the communications sector and information technology sectors were the most significantly impacted by this exploited vulnerability based on this sector-based impact analysis.

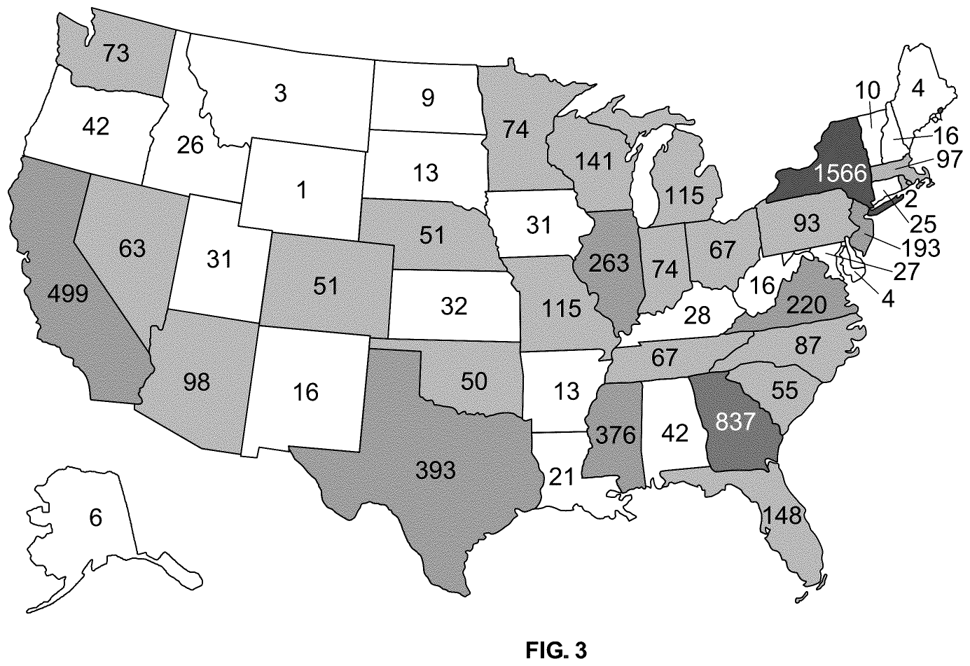

FIG. 3 illustrates an example of a region-based impact analysis of a known exploited vulnerability in accordance with some embodiments.

Specifically, FIG. 3 illustrates an example of a sector-based impact analysis of the IOS XE zero-day vulnerability tracked as CVE-2023-20198 that was being exploited to hack the Cisco devices. As shown, the New York state and South Carolina state regions were the most significantly impacted by this exploited vulnerability based on this sector-based impact analysis.

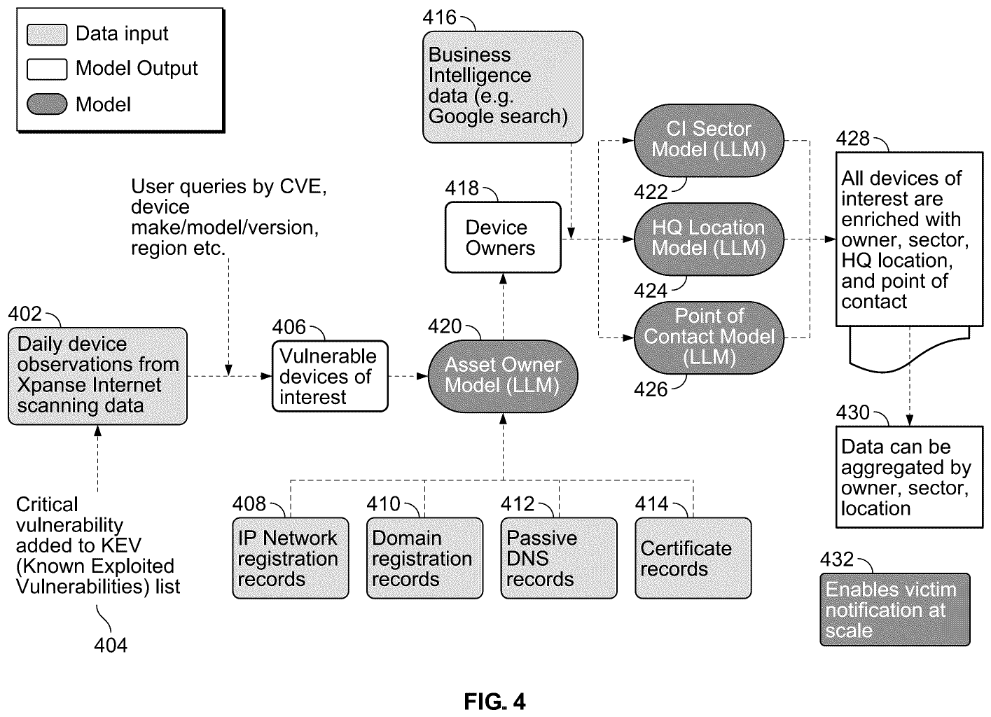

FIG. 4 illustrates an example system architecture for an AI-enabled device ownership identification system for securing nationwide critical infrastructure systems in accordance with some embodiments.

Referring to FIG. 4, at 402, daily device observations are collected from Internet scanning data. In an example implementation, device observations can be generated using an Internet scanning tool (e.g., an Internet scanning tool that is a commercially available or publicly available/open source Internet scanning tool that facilitates identification of distinct types of devices, operating systems/platforms, etc., can be used).

At 404, critical vulnerability information (e.g., CVEs) is added to a known exploited vulnerabilities (KEV) data set (e.g., a list or table, etc.).

At 406, a set of vulnerable devices of interest is determined, which can be determined based on the collected daily device observations (402) based on the subset of devices that may be impacted by the KEVs (404).

Additional meta information is collected that can be utilized by the fine-tuned LLMs, which as shown in FIG. 4, include an asset owner model (LLM) 420, a CI sector model (LLM) 422, a headquarters (HQ) location model (LLM) 424, and a point of contact model (LLM) 426. The additional meta information in this example implementation includes the following: IP network registration records 408, domain registration records 410, passive DNS records 412, certificate records 404, and business intelligence data 416 (e.g., based on Internet search engine searches (e.g., a Google search, a Bing search, or an AI-based search, such as using Google, Microsoft Bing/Copilot, etc., of various entities)). In an example implementation, AI/ML/LLM (artificial intelligence/machine learning/large-language model) models can be combined with business intelligence data sources to enrich asset ownership information with sector, HQ location, and contact information for each device, facilitating rapid and efficient response to emerging threats, such as will now be further described below.

As shown at 418, asset owner model (LLM) 420 automatically identifies the device owners (418) for each of the vulnerable devices of interest 406 utilizing the above-described meta information as contextual input into the model. In an example implementation, AI/ML/LLM models can be used to accurately attribute devices to their respective owners and streamline the coordination of remediation efforts.

The CI sector model (LLM) 422 automatically identifies the CI sector for each of the identified device owners (418) for each of the vulnerable devices of interest (406) utilizing the above-described meta information as contextual input into the model. In an example implementation, AI/ML/LLM models can be used to automatically analyze and identify the sectors most impacted by specific vulnerabilities, enabling stakeholders to, for example, prioritize response and remediation efforts for the highest risk areas.

The HQ location model (LLM) 424 automatically identifies the HQ location for each of the identified device owners (418) for each of the vulnerable devices of interest (406) utilizing the above-described meta information as contextual input into the model. In an example implementation, the HQ location model (LLM) can parse the address out of a text string returned from an Internet search for the entity (e.g., a Google or Bing search, etc.).

The point of contact model (LLM) 426 automatically identifies the point of contact (POC) for each of the identified device owners (418) for each of the vulnerable devices of interest (406) utilizing the above-described meta information as contextual input into the model.

At 428, all devices of interest are enriched with owner, sector, HQ location, and point of contact information based on the output from each of the models/LLMs 420, 422, 424, and 426, such as similarly described above and as will be further described below.

At 430, the data can be aggregated by owner, sector, location, etc.

As such, as shown at 432, the aggregation of such asset related data for vulnerable devices of interest as correlated to KEVs facilitates victim notification at scale, which can be used to effectively and efficiently provide for securing nationwide critical infrastructure systems.

For example, a security researcher may discover new exploits and add them to this catalog (e.g., KEVs). As such, the key questions for a cybersecurity entity or another entity focused on safeguarding critical infrastructure for a country, state, enterprise, government, or another entity can include: for a given exploit, what is vulnerable? What critical infrastructure (such as water, energy, and transportation) may be impacted? These questions can be answered effectively and efficiently using the above-described AI-enabled device ownership identification system for securing nationwide critical infrastructure systems, such as will be further described below.

Further, the above-described example system architecture for an AI-enabled device ownership identification system for securing nationwide critical infrastructure systems is a highly scalable solution that provides real-time comprehensive information for, for example, millions of devices, including identification of asset owners of cloud hosted devices.

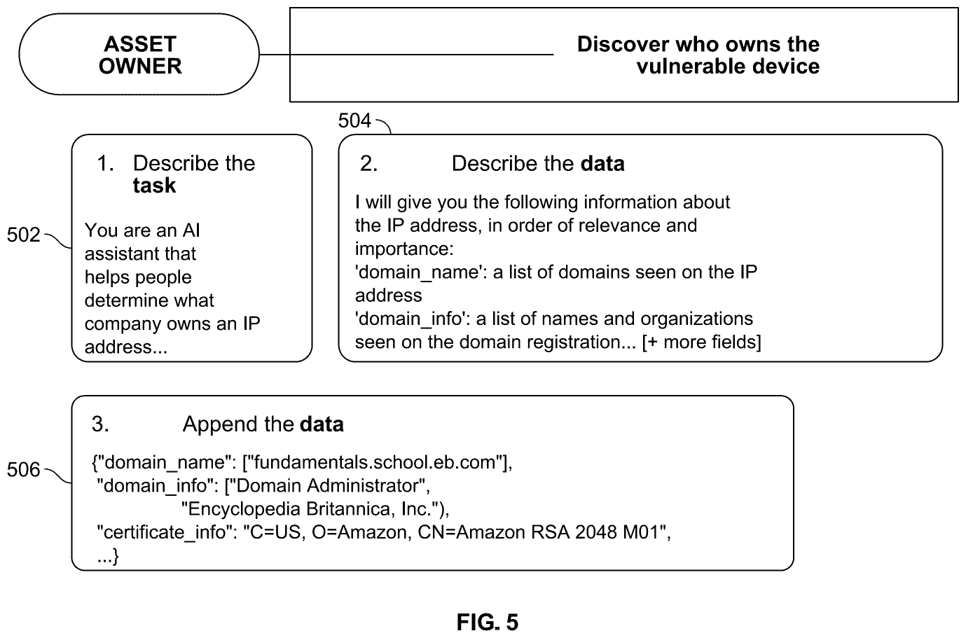

FIG. 5 illustrates an example for prompting an LLM for asset owners of vulnerable devices in accordance with some embodiments.

A general pattern for an LLM prompt includes the following:
(1) Explain the task;
(2) Explain the data (e.g., and in some cases, rank its importance); and
(3) Append the data (e.g., append the row-specific data).

Referring to FIG. 5, this general pattern for an LLM prompt can be applied to determine asset owners of vulnerable devices, such as similarly described above with respect to FIG. 4.

As shown at 502, the LLM prompt to explain the task for this example of prompting the LLM for asset owners of vulnerable devices can include the following:
“You are an AI assistant that helps people determine what company owns an IP address . . . ”

As shown at 504, the LLM prompt to explain the data for this example of prompting the LLM for asset owners of vulnerable devices can include the following:
“I will give you the following information about the IP address, in order of relevance and importance:
‘domain_name’: a list of domains seen on the IP address
‘domain_info’: a list of names and organizations seen on the domain registration [+ more fields]
. . . .”

As shown at 506, the LLM prompt to append the data for this example of prompting the LLM for asset owners of vulnerable devices can include the following:
“{“domain_name”: [“fundamentals.school.eb.com”],
“domain_info”: [“Domain Administrator”,
“Encyclopedia Britannica, Inc.”],
“certificate_info”: “C=US,O=Amazon,CN=Amazon RSA 2048 M01”,
. . . }.”

In some cases (not shown in this example), few-shot learning can be provided by including a few examples as a prompt input to the LLM.

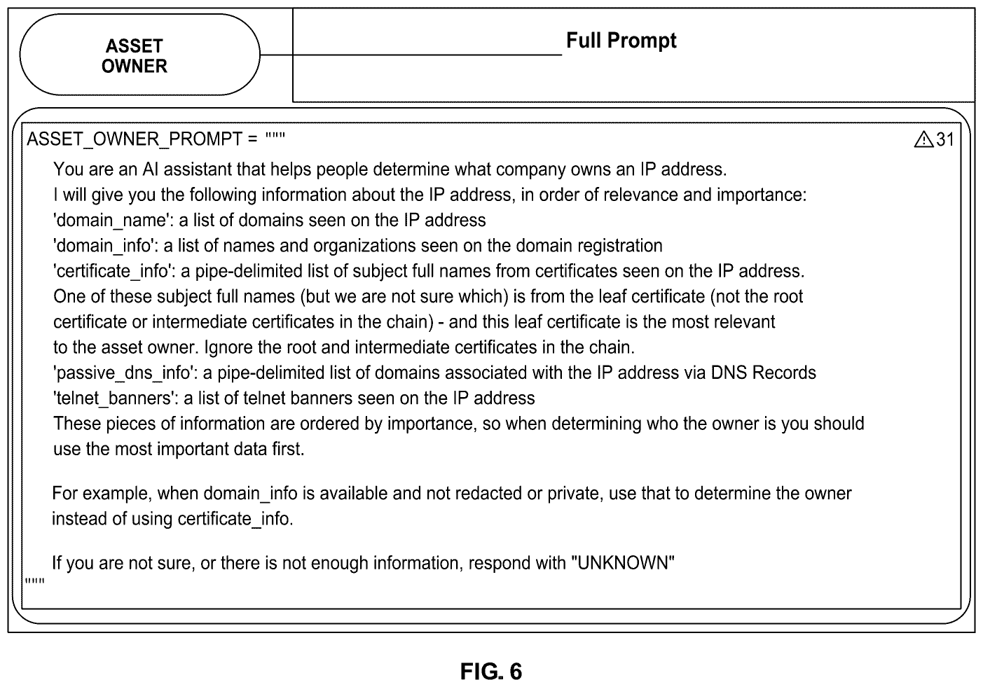

FIG. 6 illustrates an example full prompt of an LLM for asset owners of vulnerable devices in accordance with some embodiments. As shown in FIG. 6, the prompt includes an identification of the data and its relative importance (e.g., “when domain_info is available and not redacted or private, use that to determine the owner instead of using certificate_info”). This example full prompt also includes text to improve accuracy and avoid potential inaccurate, hallucinatory responses from the LLM (e.g., “If you are not sure, or there is not enough information, respond with ‘UNKNOWN’). It is noted that in this example implementation, if it is unable to predict anything specific, then we can still provide the IP registrant as the asset owner.

Based on our experiments (e.g., in which we provided data on 25 major CVEs, with more than 200,000 instances of CVEs detected and approximately 60,000 owners attributed), asset owner accuracy was approximately 75% using the above-described techniques for AI-enabled ownership identification for securing nationwide critical infrastructure systems. For the identification of the asset owner, the accuracy is generally related to whether the LLM can predict something more specific than the IP registrant (e.g., which is very often a CSP/ISP).

Similarly, based on our experiments, sector classification was approximately 85% using the above-described techniques for AI-enabled ownership identification for securing nationwide critical infrastructure systems.

For example, many customers desire such owner and sector classification in order to specifically identify device owners/sectors that are hosted on cloud or communication providers (e.g., AT&T, Comcast, etc.).

In an example implementation, a commercially available or publicly available, open source LLM solution can be utilized to implement the above-described techniques for AI-enabled ownership identification for securing nationwide critical infrastructure systems, such as using Azure OpenAI LLMs, Google Vertex LLMs, Meta Llama LLMs, and/or other LLMs.

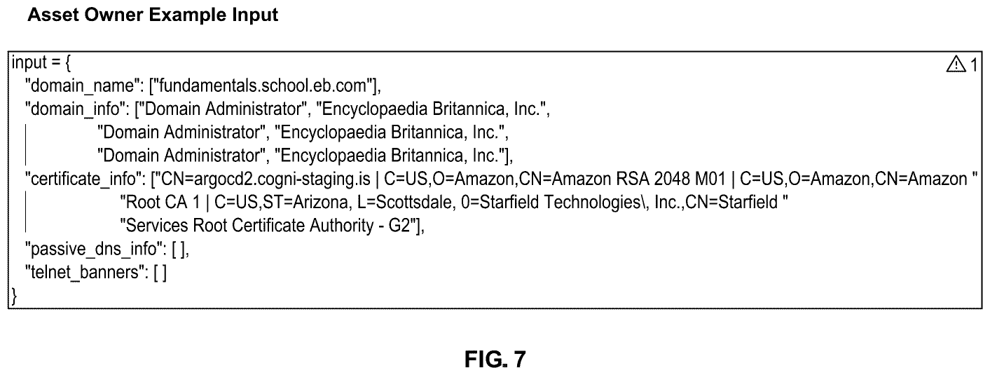

FIG. 7 illustrates an asset owner example input in accordance with some embodiments. As shown, the asset owner input can include a domain name, domain information, certificate information, passive DNS information, and telnet banners.

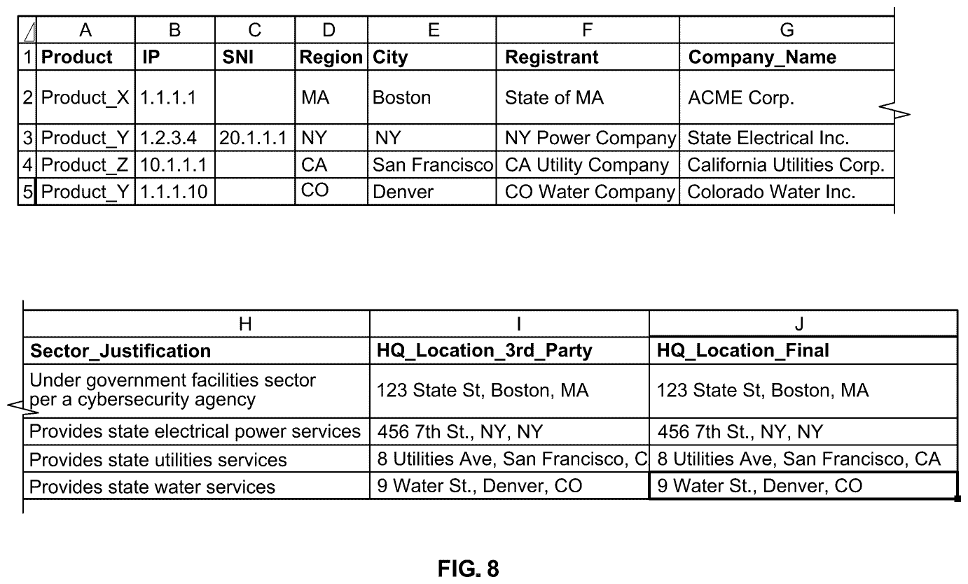

FIG. 8 illustrates an example output generated using the AI-enabled device ownership identification system for securing nationwide critical infrastructure systems in accordance with some embodiments. As shown in FIG. 8, the above-described AI-enabled device ownership identification system for securing nationwide critical infrastructure systems, such as shown in FIG. 4, can be used to generate the example output that is a listing (e.g., spreadsheet) that includes fields for the product for each device/asset; the associated IP address; the Server Name Indication (SNI); location fields including region/state, city; device/asset owner information fields including Registrant; entity/company name; sector related fields including sector and sector justification; and HQ location related fields including HQ location based on third party data source(s) and HQ location final determination.

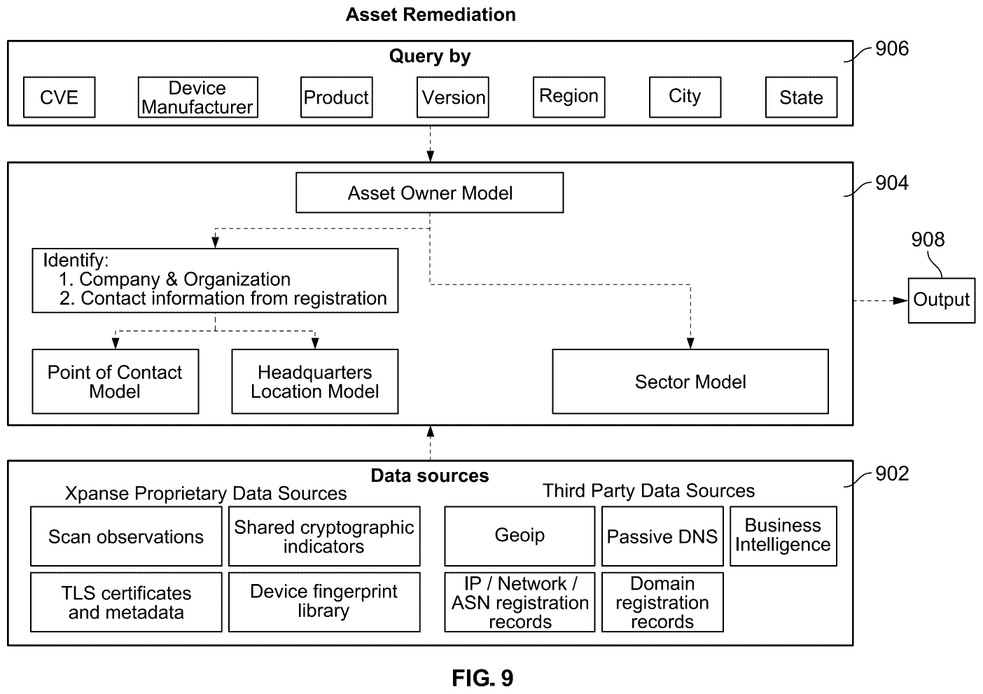

FIG. 9 illustrates an asset remediation solution using the AI-enabled device ownership identification system for securing nationwide critical infrastructure system in accordance with some embodiments. As similarly described above, the disclosed AI-enabled device ownership identification system for securing nationwide critical infrastructure systems utilizes one or more AI/ML models, such as the above-described LLMs, to analyze data and make recommendations on the output, such as for asset remediation based on KEVs, as shown in FIG. 9.

Referring to FIG. 9, various data sources are used as shown at 902, including internal/proprietary data sources (e.g., scan observations, TLS certificates and metadata, shared cryptographic indicators, and device fingerprints/fingerprint library) and third party data sources (e.g., geographical IP related location data, IP/network/ASN registration records, passive DNS, domain registration records, and business intelligence). The data sources are provided as input into the various AI/ML models/LLMs, including an asset owner model, a point of contact model, a headquarters model, and a sector model, as shown at 904.

As also shown, a user can utilize the disclosed AI-enabled device ownership identification system for securing nationwide critical infrastructure for performing asset remediation. At 906, a user can query the system based on one or more of the following: CVE, device manufacturer, product, version, region, city, state, and/or other attributes/information.

The disclosed AI-enabled device ownership identification system for securing nationwide critical infrastructure can process the query to generate a responsive output as shown at 908. In an example implementation, the output can include a listing/spreadsheet of the responsive data/information based on the query, such as shown in FIG. 8.

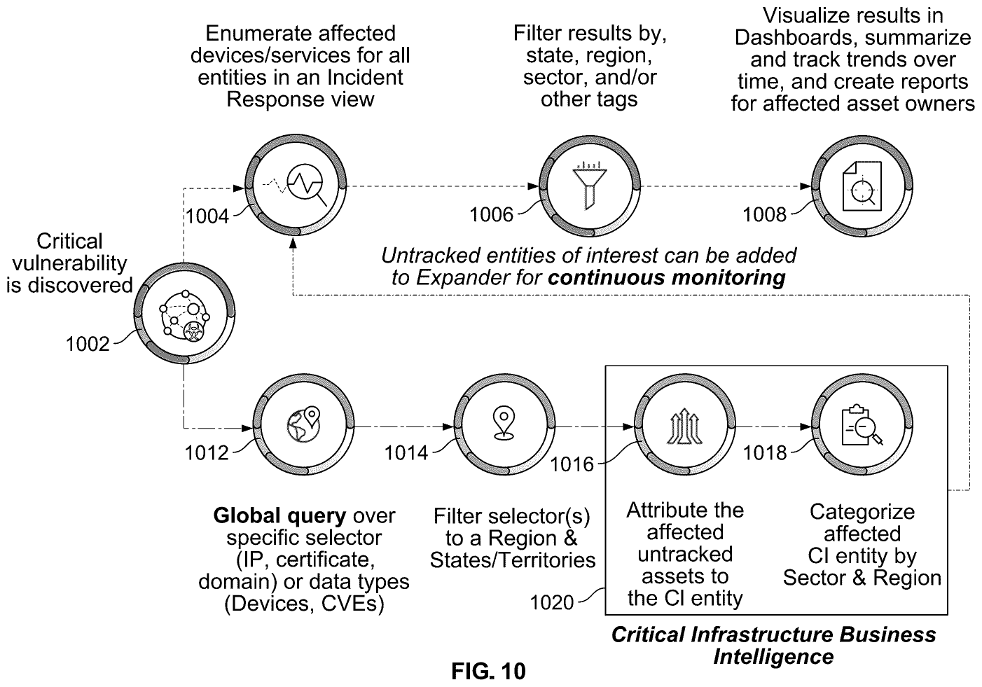

FIG. 10 illustrates a workflow example using the AI-enabled device ownership identification system for securing nationwide critical infrastructure in accordance with some embodiments. Specifically, FIG. 10 provides a workflow example for a new KEV list vulnerability using the AI-enabled device ownership identification system for securing nationwide critical infrastructure systems, such as similarly described above with respect to FIGS. 4 and 9.

Referring to FIG. 10, at 1002, a new critical vulnerability is discovered.

At 1004, as part of this workflow, the disclosed AI-enabled device ownership identification system for securing nationwide critical infrastructure is applied to enumerate affected devices/services for all mapped entities in an Incident Response view (e.g., of the tool/system).

At 1006, the results are filtered by state, region, sector, and/or other tags/attributes.

At 1008, visualizations of the results are automatically generated, such as in dashboards or other visualizations, to summarize and track trends over time and create reports for affected asset owners.

As also shown as part of the ILI workflow in FIG. 10, at 1012, a global query over specific selector (e.g., IP, certificate, domain, etc.) or other data types (e.g., devices, CVEs, etc.) is entered into the AI-enabled device ownership identification system for securing nationwide critical infrastructure systems.

At 1014, the selector(s) are filtered to a given region and states/territories.

At 1016, the affected untracked assets are attributed to the relevant CI entity.

At 1018, the affected CI entity is categorized by sector and region.

As also shown in FIG. 10, the processed critical infrastructure business intelligence 1020 can be fed back into processing stage 1004 for enumerating affected devices/services for selected CI entities in the Incident Response view.

Various process embodiments for providing artificial intelligence-enabled (AI-enabled) device ownership identification for securing nationwide critical infrastructure will now be further described below.

### Example Process Embodiments for AI-Enabled Device Ownership Identification for Securing Nationwide Critical Infrastructure Systems

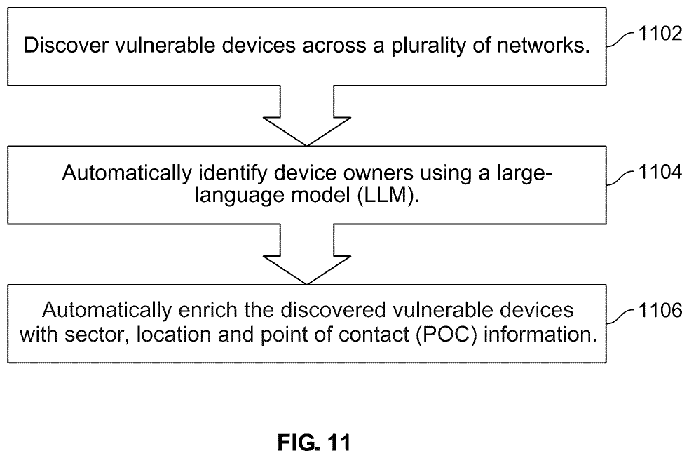

FIG. 11 is a flow diagram for providing artificial intelligence-enabled (AI-enabled) device ownership identification for securing nationwide critical infrastructure systems in accordance with some embodiments. In some embodiments, a process as shown in FIG. 11 is performed by a system, such as shown in FIG. 4, and techniques as similarly described above including the embodiments described above with respect to FIGS. 1-10.

At 1102, discovering vulnerable devices across a plurality of networks is performed, such as similarly described above with respect to FIGS. 1-10.

At 1104, automatically identifying device owners using a large-language model (LLM) is performed, such as similarly described above with respect to FIGS. 1-10.

At 1106, automatically enriching the discovered vulnerable devices with sector, location and point of contact (POC) information is performed, such as similarly described above with respect to FIGS. 1-10.

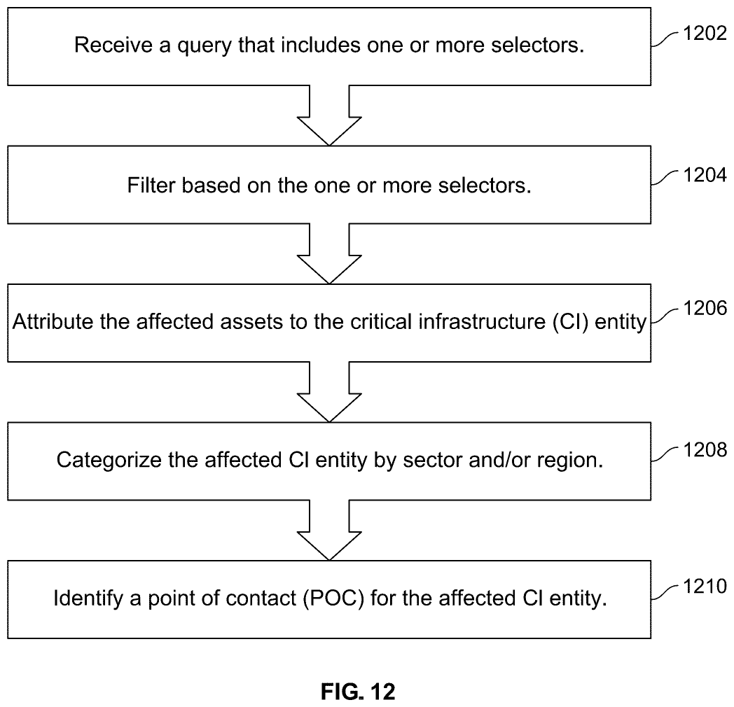

FIG. 12 is a flow diagram for providing artificial intelligence-enabled (AI-enabled) device ownership identification for securing nationwide critical infrastructure systems in accordance with some embodiments. In some embodiments, a process as shown in FIG. 11 is performed by a system, such as shown in FIG. 4, and techniques as similarly described above including the embodiments described above with respect to FIGS. 1-10.

At 1202, a query is received that includes one or more selectors, such as similarly described above with respect to FIG. 10. Example selectors can include CVEs and/or device identifiers (e.g., device make/model/version, etc.). Source selectors can be automatically pulled from various data sources/feeds, such as KEV, NVD (e.g., a national vulnerability database, in which NVD refers to the U.S. government repository of standards based vulnerability management data represented using the Security Content Automation Protocol (SCAP)) and/or other sources/feeds.

At 1204, filtering based on the one or more selectors is performed, such as similarly described above with respect to FIG. 10. In an example implementation, the selector(s) observations can be correlated with geo IP information to organize results by, for example, predetermined regions and state/territory.

At 1206, attributing the affected assets to the critical infrastructure (CI) entity is performed, such as similarly described above with respect to FIG. 10. As similarly described above, various business intelligence data sources can be used to further enrich asset ownership information.

At 1208, the affected CI entity is categorized by sector and/or region, such as similarly described above with respect to FIG. 10. For example critical infrastructure (CI) labels can be applied based on affected asset owners' sector affiliation, HQ location, and/or assigned regional office for a national cybersecurity entity.

At 1210, a point of contact (POC) is identified for the affected CI entity, such as similarly described above with respect to FIG. 10. As similarly described above, the POC is identified as a person or group associated with the affected asset owner(s) to receive notifications (e.g., for remediation, etc.).

In an example implementation, reports can also be automatically generated based on the above-described asset remediation processing. Also, automated notifications can be generated. For example, an automated report and notification can be generated and sent to the POCs at affected asset owners. The report can include executive summaries and/or raw data, such as similarly described above.

In addition, incident response can be tracked in this example implementation. For example, statistics for mean time to detect (MTTD) and mean time to resolve (MTTR) can be tracked and are filterable by sector, region, and/or remediation status.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
discover vulnerable devices across a plurality of networks;
automatically identify device owners using a large-language model (LLM); and
automatically enrich the discovered vulnerable devices with sector, location, and point of contact (POC) information; and
a memory coupled to the processor and configured to provide the processor with instructions.

2. The system of claim 1, wherein nationwide incident response to known exploited vulnerabilities is performed using the discovered vulnerable devices, the identified device owners, and enriched information associated with the discovered vulnerable devices, wherein the enriched information includes certificate or domain registration information associated with the identified device owners.

3. The system of claim 1, wherein the LLM is prompted to facilitate identifying the device owners.

4. The system of claim 1, wherein the LLM is prompted to facilitate identifying the device owners including instructions to prioritize predetermined information for identifying the device owners.

5. The system of claim 1, wherein the processor is further configured to:
generate an output that includes a plurality of fields including device information, IP address, location information, device owner information, and POC information.

6. The system of claim 1, wherein the processor is further configured to:
execute an asset owner model to facilitate identifying the device owners.

7. The system of claim 1, wherein the processor is further configured to:
execute a point of contact model, a headquarters location model, and a sector model to facilitate automatically enriching the discovered vulnerable devices with the sector, location and POC information.

8. A method, comprising:
discovering vulnerable devices across a plurality of networks;
automatically identifying device owners using a large-language model (LLM); and
automatically enriching the discovered vulnerable devices with sector, location, and point of contact (POC) information.

9. The method of claim 8, wherein nationwide incident response to known exploited vulnerabilities is performed using the discovered vulnerable devices, the identified device owners, and enriched information associated with the discovered vulnerable devices, wherein the enriched information includes certificate or domain registration information associated with the identified device owners.

10. The method of claim 8, wherein the LLM is prompted to facilitate identifying the device owners.

11. The method of claim 8, wherein the LLM is prompted to facilitate identifying the device owners including instructions to prioritize predetermined information for identifying the device owners.

12. The method of claim 8, further comprising:
generating an output that includes a plurality of fields including device information, IP address, location information, device owner information, and POC information.

13. The method of claim 8, further comprising:
executing an asset owner model to facilitate identifying the device owners.

14. The method of claim 8, further comprising:
executing a point of contact model, a headquarters location model, and a sector model to facilitate automatically enriching the discovered vulnerable devices with the sector, location and POC information.

15. A computer program product embodied in a non-transitory computer readable medium and comprising computer instructions for:
discovering vulnerable devices across a plurality of networks;
automatically identifying device owners using a large-language model (LLM); and
automatically enriching the discovered vulnerable devices with sector, location, and point of contact (POC) information.

16. The computer program product of claim 15, wherein nationwide incident response to known exploited vulnerabilities is performed using the discovered vulnerable devices, the identified device owners, and enriched information associated with the discovered vulnerable devices, wherein the enriched information includes certificate or domain registration information associated with the identified device owners.

17. The computer program product of claim 15, wherein the LLM is prompted to facilitate identifying the device owners.

18. The computer program product of claim 15, wherein the LLM is prompted to facilitate identifying the device owners including instructions to prioritize predetermined information for identifying the device owners.

19. The computer program product of claim 15, further comprising computer instructions for:
generating an output that includes a plurality of fields including device information, IP address, location information, device owner information, and point of contact (POC) information.

20. The computer program product of claim 15, further comprising computer instructions for:
executing an asset owner model to facilitate identifying the device owners.
